(19) United States
(12) Patent Application Publication
(10) Pub. No.: US 2021/0069966 A1
(43) Pub. Date: Mar. 11, 2021

(54) FULL COLOR GAMUT, HIGH RESOLUTION THREE-DIMENSIONAL OBJECT

(71) Applicant: Rize, Inc., Woburn, MA (US)

(72) Inventors: Nathalie P. O'Hara, Bedford, MA (US); Alexey Zhuravlev, Woburn, MA (US); Thomas Davidson, Lexington, MA (US); Eugene Giller, Wellesley, MA (US)

(21) Appl. No.: 16/961,522

(22) PCT Filed: Jan. 11, 2019
(86) PCT No.: PCT/US19/13383

§ 371 Date: Jul. 10, 2020

Related U.S. Application Data
(60) Provisional application No. 62/616,787, filed on Jan. 12, 2018.

(51) Int. Cl. B29C 64/135; B29C 64/112

(52) U.S. Cl. CPC B29C 64/135; B33Y 10/00; B29C 64/112

(57) ABSTRACT

A fabrication process and method for producing grayscale or full color three-dimensional objects by depositing a first part material layer, printing a first colorization layer on to the first part material layer, depositing a second part material layer on to the first colorization layer, and printing a second colorization layer on to the second part material layer. The part material deposition and coloring agent deposition operations may be repeated until a three-dimensional colored object is formed. The colorization inks used to form at least one of the first and second colorization layers allow the creation of grayscale or full color 3D printed parts. The process facilitates deposition of colorization agents on a part material to produce full color parts, improves color gamut and resolution, allows creation of hidden features within parts (e.g., wear indicators), and enhances aesthetics and functionality of three-dimensional objects with the use of color.

### CROSS-REFERENCE TO RELATED APPLICATIONS

This application is the U.S. National Stage of International Application No. PCT/US19/13383, filed Jan. 11, 2019, which claims the benefit of U.S. Provisional Application No. 62/616,787, filed on Jan. 12, 2018, entitled “Method And Process To Produce Full Color Gamut, High Resolution Three-Dimensional Object By Layer Manufacturing,” the entirety of each of which are hereby incorporated by reference.

### BACKGROUND

### Field

Embodiments of the present disclosure relate to three-dimensional printing and, in particular, to processes for applying color and forming an image on three-dimensional printed objects, and to processes which enhance the utilization in color in the production of three-dimensional printed parts.

Production of manufactured parts can include initial forming processes that produce an initial work piece and finishing processes that produce a final part from the initial work piece; Because finishing operations can represent more than half the total cost of producing a manufactured item, it can be desirable to reduce or eliminate finishing processes from manufacture of parts.

Additive manufacturing, also referred to as layer manufacturing or three-dimensional (3D) printing, is a forming process that can employ computer aided design (CAD) outputs to build an object on a layer-by-layer and point-by-point basis to form objects. In particular, additive manufacturing has been employed successfully for fabrication of many types of polymer objects.

### SUMMARY

Conventionally fabricated polymer objects can be colored. While additive manufacturing techniques have been developed to form colored polymer objects, the parts produced by these processes experience some shortcomings.

In one example, parts created by binder jetting have good color but they lack the mechanical strength to make them functional. With the binder jetting technology, achieving bright color also requires the additional step of post-processing the part, for example, by infiltrating with cyanoacrylate or dipping the part in wax, which is cumbersome, time consuming, and requires special equipment. Paper based technology can produce full color parts, but parts lack mechanical strength and can only be used for concept modeling.

In another example, color parts can be produced by additive manufacturing based on deposition of colored polymer filaments. However this technique does not produce entirely full color parts, as the filaments limit the color combinations. Furthermore, the color cannot be varied within one layer, or controlled at the voxel level. Rather, the color is switched between layers, forming a color gradient or striped colored part. Even if it were possible to blend different filaments to produce additional colors, this technique would still be limited to producing stripes or gradients of colors. For these reasons, this approach does not allow for the reproduction of images with fine details.

In a further example, techniques have been developed for applying color to the surface of a polymer object after forming by additive manufacturing. In one aspect, an ink can be jetted on the exterior surface of a polymer object formed by additive manufacturing. However, such ink jetting processes are time consuming, as application of the ink adds an extra step to the manufacturing process. Also, as it is difficult to conform the color to the shape and geometry of complex objects, ink jetting processes performed post-deposition can lack precision.

In another aspect, nylon parts formed by selective laser sintering (SLS) printers can be dyed. However, SLS formed parts are typically colored after the object is printed by dip coating. Adding color in this manner results in color being applied only on the exterior surface of the object, which can be non-permanent, as the color eventually wears and rubs off. Furthermore, it is uncommon to employ more than one color, as the coloring is imprecise and tends to run, lacking well defined contrast between different colors.

Printers based on Polyjet technology (UV curable colorization agents) allow for the creation of color parts with good details and resolution, controllable at the voxel level. However, the range of colors achievable is limited to the combinations made possible by a limited palette of colors. In addition, parts made from this technology are brittle and become weaker and more fragile over time. The process also requires a post-processing step to remove supports and clean the part.

Accordingly, there is a need for improvements to processes for improving how color is added to printed three-dimensional objects/parts. Embodiments of the present disclosure are directed toward further solutions to address this need, in addition to having other desirable characteristics.

Specifically, in certain embodiments, systems and processes are provided that improves deposition of colorization agents on a part material to produce full color parts, improves color gamut and resolution to create hidden features within parts (e.g., wear indicators), and otherwise enhances aesthetics and functionality of three-dimensional objects with the use of color. More specifically, the disclosed embodiments provide a three-dimensional manufacturing method and apparatus able to control color at the voxel level to produce grayscale and full color three-dimensional parts with good color accuracy and high resolution, color gamut, and color quality from a layer manufacturing system, without the need for additional post-processing. These embodiments address the issue of reproducing images with high resolution and improved color gamut and facilitate production of high resolution, high quality color parts of all geometries. In further embodiments, a method for deposition of coloring agent to reproduce high fidelity images on vertical surfaces is further provided.

In an embodiment, a method is provided for applying coloring during a three-dimensional fabrication process. The method can include virtually slicing, using a processor, a digital representation of a three-dimensional object with color into a plurality of two dimensional cross-section layers. The method can also include identifying, using the processor, areas containing color within each of the plurality of two dimensional cross-section layers of the three-dimensional object. The method can further include generating, using the processor, a bitmap for each of the plurality of two dimensional cross-section layers containing the areas containing color. The method can additionally include depositing, using the three-dimensional fabrication apparatus in an additive process, a first part material layer corresponding to a first layer of the plurality of two-dimensional cross-section layers. The method can also include depositing, using the three-dimensional fabrication apparatus in an additive process, at least one first coloring layer on at least a portion of the first part material layer. The method can further include depositing, using the three-dimensional fabrication apparatus in an additive process, a second part material layer corresponding to a second layer of the plurality of two-dimensional cross-section layers on the at least one first coloring layer.

In an embodiment, the at least one first coloring layer can be deposited at a predetermined distance from an exterior edge of the first part material layer.

In another embodiment, the predetermined distance can be dimensioned such that a feature formed by the at least at least one first coloring layer is invisible from an external edge of the three-dimensional object under illumination by ambient light.

In another embodiment, the predetermined distance can be such that a feature formed by the at least at least one first coloring layer can be visible from an external edge of the three-dimensional object under illumination by ambient light.

Embodiments of the predetermined distance can adopt a variety of configuration. In one aspect, the predetermined distance exceeds a pixel width. In another aspect, the first coloring layer covers only one pixel width. In a further aspect, the first coloring layer covers a width of multiple pixels. In an additional aspect, the multiple pixels are adjacent to one another. In a further aspect, the multiple pixels are not adjacent to one another.

In another embodiment, the number of multiple pixels can be adjusted (e.g., by the processor) based upon a brightness of a pixel of an image formed by the first coloring layer that is closest to an external edge of the three-dimensional object.

Embodiments of the feature can adopt a variety of configurations. In one aspect, the feature can be a watermark or security feature that is only visible under illumination by electromagnetic radiation of a predetermined wavelength range. In another aspect, the feature can be a wear indicator that is only visible when external edges of the part material layers are worn off of the three-dimensional object to a depth exceeding the predetermined depth.

In another embodiment, at least one of the first and second part material layers can be configured to undergo a phase separation over time to transition from a clear or transparent appearance to opaque appearance.

In another embodiment, the at least one first coloring layer can be configured to undergo a phase change when deposited on the part material layers.

In another embodiment, at least one second coloring layer can be deposited on the first part material layers at a different depth within the three-dimensional object different than of the first part material, thereby creating a monochromatic background to a color image created by the at least one first coloring layer.

In another embodiment, the method can include depositing, using the three-dimensional fabrication apparatus in an additive process, a support structure material layers to form a support structure. The support structure can be configured to provide mechanical support to at least one overhang portion formed in the three dimensional object by the first and second part material layers.

In another embodiment, the method can further include depositing, using the three-dimensional fabrication apparatus, a release layer between the support structure and either of the first and second part material layer.

In another embodiment, the release layer and the coloring layer can be formed from materials that are immiscible with respect to one another.

In another embodiment, the at least one first coloring layer includes a color ink.

In another embodiment, the first and second of part material layers can be formed from a polymer material.

In another embodiment, the at least one coloring layer can be configured to achieve at least partially diffuse into at least one of the first part material layer and the second part material layer.

In another embodiment, the first and second part material layers can be partially soluble in the at least one first coloring layer.

In another embodiment, the identified area of the object having color can be converted into a two-dimensional image file.

In another embodiment, the first and second part material layers can be translucent.

In another embodiment, a translucency of at least one of the first and second part materials layers can be adjusted to achieve a predetermined Chroma minimum between vertical and horizontal surfaces of a three dimensional object formed therefrom. A difference in Chroma, of a same color or image formed by the first coloring layer, between horizontal and vertical surfaces of the three-dimensional object can be less than 30 units and more less than 20 units.

In an embodiment, a method creating a visual effect in a translucent three-dimensional object is provided. The method can include forming, by a three-dimensional fabrication apparatus, a three-dimensional object through an additive manufacturing process. The three-dimensional object can include a plurality of part material layers and at least one coloring layer applied upon at least one of the plurality of part material layers. The method can further include selecting, by the three-dimensional fabrication apparatus, at least one extruding pattern for at least one part layer of the plurality of part layers. The method can additionally include extruding, by the three-dimensional fabrication apparatus, the at least one extruding pattern at the at least one part layer within the plurality of part layers to create the visual effect.

In another embodiment, the at least one extruding pattern can be configured to deposit the at least one part layer in a dense pattern configured to minimize light scattering and maintain translucency of the at least one coloring layer within the three-dimensional object.

In another embodiment the at least one extruding pattern can be configured to deposit the at least one part layer with air pockets configured to increase light scattering and reduce translucency of the at least one coloring layer within the three-dimensional object.

In another embodiment, the at least one extruding pattern can be configured to deposit the at least one part layer in an infill grid underneath exterior edges of the plurality of part material layers that create a white appearance when the plurality of part material layers are translucent or transparent materials.

In another embodiment, the method can also include texturing a surface of the three-dimensional object to increase opacity/reduce translucency. The texturing can include chemically applying plasticizer or physically indenting the surface of the three-dimensional object.

In an embodiment, a system is provided and it can include a computing device and a three-dimensional fabrication apparatus. The computing device can include at least one processor configured to execute instructions operative to virtually slice a digital representation of a three-dimensional object with color into a plurality of two-dimensional cross-section layers. The executed instructions are further operative to identify areas containing color within each of the plurality of two-dimensional cross-section layers of the three-dimensional object. The executed instructions are also operative to generate a bitmap for each of the plurality of two-dimensional cross-section layers containing the areas containing color. The three-dimensional fabrication apparatus can include an extruder assembly and a print head. The three-dimensional fabrication apparatus can be configured to deposit, by the extruder assembly, a first part material layer corresponding to a first layer of the plurality of two-dimensional cross-section layers. The three-dimensional fabrication apparatus can also be configured to deposit, by the print head, at least one first coloring layer on at least a portion of the first part material layer. The three-dimensional fabrication apparatus can be further configured to deposit, by the extruder assembly, a second part material layer corresponding to a second layer of the plurality of two-dimensional cross-section layers on the at least one first coloring layer.

In accordance with example embodiments of the present disclosure, system for applying coloring to a three-dimensional fabrication process according to the method disclosed herein is provided in various operable combinations.

### BRIEF DESCRIPTION OF THE FIGURES

The patent or application file contains at least one drawing executed in color. Copies of this patent or patent application publication with color drawing(s) will be provided by the Office upon request and payment of the necessary fee.

These and other characteristics of the disclosed embodiments will be more fully understood by reference to the following detailed description in conjunction with the attached drawings, in which:

FIG. 1 is a side cross-sectional view illustrating one exemplary embodiment of a three-dimensional fabrication apparatus;

FIG. 2A is a flow diagram illustrating an exemplary embodiments of a process for adding color to a part material layer during formation of a three-dimensional object by the three-dimensional fabrication apparatus of FIG. 1;

FIG. 2B is a flow diagram illustrating one exemplary embodiment of a method for adding color during formation of a three dimensional object and a support structure by the three-dimensional fabrication apparatus of FIG. 1;

FIGS. 3A and 3B are schematic representations of color deposition on one layer of deposited part material to apply images that are viewable from vertical surfaces of an object;

FIG. 4 is a schematic representation of color deposition on one layer of deposited part material to apply color inside the deposited material to create features such as wear/tear indicators, or watermarks or other security feature;

FIGS. 5A-5D are photographs illustrating color deposited, according to embodiments of the present disclosure, on a top facing surface of part materials formed from a cyclo-olefin polymer compounded with different levels of boron nitride (BN); (5A) 2 wt. % BN; (5B) 5 wt. % BN; (5C) 10 wt. % BN; (5D) 20 wt. % BN;

FIGS. 5E-5H are photographs illustrating an ink deposited, according to embodiments of the present disclosure, on a second to last surface of part materials formed from a cyclo-olefin polymer compounded with different levels of boron nitride (BN); (5E) 2 wt. % BN; (5F) 5 wt. % BN; (5G) 10 wt. % BN; (5H) 20 wt. % BN;

FIGS. 6A-6D are photographs illustrating an image printed with an ink, according to embodiments of the present disclosure, within a depth of four pixels of an external surface of part materials formed from a cyclo-olefin polymer compounded with different levels of boron nitride (BN); (6A) 2 wt. % BN; (6B) 5 wt. % BN; (6C) 10 wt. % BN; (6D) 20 wt. % BN;

7A is a photograph illustrating text printed with an ink on a vertical external surface and an image printed on an internal horizontal surface of part materials formed from a blend of cyclo-olefin polymers which is partially soluble in the ink, according to embodiments of the present disclosure;

7B is a photograph illustrating text printed with an ink on a vertical external surface and an image printed on an internal horizontal surface of part materials formed from a polycarbonate which is not soluble in the ink, according to embodiments of the present disclosure;

FIG. 8A is a photograph illustrating an image printed with an ink, according to embodiments of the present disclosure, where a number of jetted pixels and a location of the jetted pixels within one, two, or three pixels from the vertical external surface of a part material;

FIG. 8B is a photograph illustrating an image printed with an ink, according to embodiments of the present disclosure, where a number of jetted pixels and a location of the jetted pixels within, two, three, or four pixels from the vertical external surface of a part material; and

FIG. 9 is an illustrative suitable computing device that can be used to implement the computing methods/functionality of the disclosed embodiments.

### DETAILED DESCRIPTION

Embodiments of the present disclosure relate to systems and processes for application of color and/or forming color patterns (e.g., images, text, etc.) on three-dimensional printed objects. Methods to enhance color in the production of full color three-dimensional printed parts are also provided. In particular, a fabrication process is disclosed for producing grayscale or full color three-dimensional objects by depositing a first layer of part material, printing a first color layer in a predetermined pattern on the first layer of part material, and depositing a second layer of part material on to the first colorization layer. The present disclosure utilizes a unique combination of operations to provide a novel utility for three-dimensional printed objects. More specifically, the inventive process improves the process of depositing colorization agents on a part material to produce full color parts, to create hidden features within parts (e.g., wear indicators), and to otherwise enhance aesthetics and functionality of three-dimensional objects with the use of color. The process provided by the present disclosure can be repeated on different layers of a printed three-dimensional object to provide different effects and utilities. The deposition and printing operations may be repeated until a three-dimensional object with colored elements is formed.

Additionally, when forming a three-dimensional object with a support structure, the coloring layer can be applied on top of a release layer. In particular, the fabrication process can start by depositing a first layer of part material, depositing a release layer on top of the first layer of part material, depositing a first colorization layer on the release layer, and depositing a second layer of part material on to the first coloring layer. As would be appreciated by one skilled in the art, both methods of applying the coloring layer can be utilized in a single three-dimensional object formation/colorization.

Depending on the fabrication and colorization process implemented, different coloring materials (e.g., ink) can be applied with different part materials to yield specific coloring effects. Similarly, the coloring layers (e.g., drops of color) can be deposited at different layer depths during the fabrication process and at different locations within the layers to yield the desired colorization/effect. The coloring can be provided for both visual aesthetic and utilization for the object being fabricated. Additionally, the part material deposition pattern can be adjusted to modify how the deposited colors are visually represented within the fabricated object.

Embodiments of the disclosure provide a system and method for providing color within a three-dimensional printing process. Throughout the disclosure different terminology is utilized to discuss both the coloring (e.g., through an introduction of colorization agents) and three dimensional fabrication process (e.g., through deposition of part material layers) as it relates to the disclosed embodiments. As would be appreciated by one skilled in the art, the utilization of the phrase colorization agents and the examples thereof (e.g., drops of coloring, jetting drops of ink, etc.) are not intended to limit the scope of the disclosed embodiments. The colorization agents of the disclosed embodiments can include any method and materials that can be deposited/formed at the pixel level on layer of part material (e.g., polymer layers) utilized in three-dimensional printing.

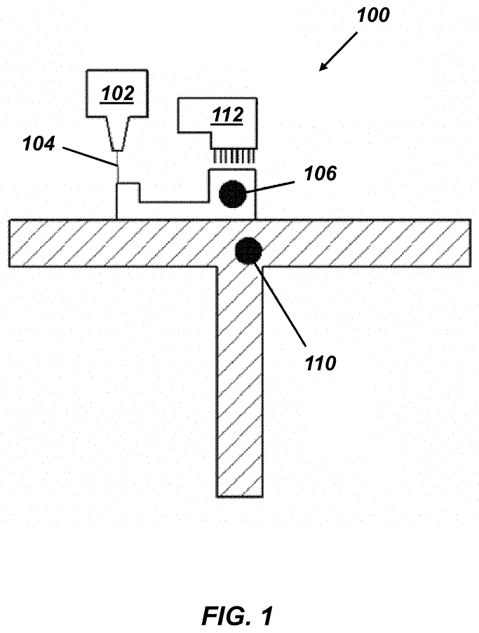

FIGS. 1 through 9, in which like parts are designated by like reference numerals throughout, illustrate embodiments of improved methods for coloring performed by a three-dimensional fabrication apparatus. Although embodiments of the present disclosure are described with reference to the figures, it should be understood that the disclosed embodiments can adopt alternative forms. One of skill in the art will additionally appreciate different ways to alter the parameters of the disclosed embodiments, such as the size, shape, or type of elements or materials, in a manner still in keeping with the spirit and scope of the present disclosure.

FIG. 1 depicts one exemplary embodiment of a three-dimensional fabrication apparatus 100. The components of the three-dimensional fabrication apparatus 100 in FIG. 1 can be in the form a deposition apparatus similar to that used for fused deposition modeling and a printing apparatus having a print head and ink delivery system. As shown, the three-dimensional fabrication apparatus 100 includes an extruder assembly 102 that dispenses a part material 104 (e.g., extrudes filament, polymer, etc.) in an additive layer-by-layer process, to form three-dimensional object 106 on build platform 110. The three-dimensional fabrication apparatus 100 also includes a print head and ink delivery system 112, which dispenses coloring (e.g., ink) on the three-dimensional object 106, a layer-by-layer process, during the build process.

A detailed explanation of the three-dimensional fabrication apparatus 100 and operation thereof is discussed in U.S. Pat. No. 9,227,366, which is incorporated herein by reference. As would be appreciated by one skilled in the art, the method and system of the disclosed embodiments are not intended to be limited for use with the three-dimensional fabrication apparatus 100 of FIG. 1 but can be applied to any suitable three-dimensional printing system capable of implementing the process as described herein without departing from the scope of the disclosed embodiments.

In certain embodiments, the extruder assembly and the print head and ink delivery system can be attached to the same mechanism such that each travels together. In alternative embodiments, the extruder assembly and the print head and ink delivery system can be attached to independent moving or stationary mechanisms that are attached to the apparatus. In further alternative embodiments, the print head and ink delivery system is aligned with the extruder assembly but not attached to the extruder assembly.

In certain embodiments, the print head and ink delivery system can include one or more print heads. Examples of print heads can include, but are not limited to, piezoelectric print heads, thermal print heads, MEMS print heads, electrostatic print heads, or combinations thereof. In alternative embodiments, the print head and ink delivery system can include a print head such as a plotter type single nozzle unit, a continuous ink jet, or a drop-on-demand system. In some embodiments, the print head of the print head and ink delivery system can be positioned at any angle within the range of +45 degrees to −45 degrees relative to the extruder assembly.

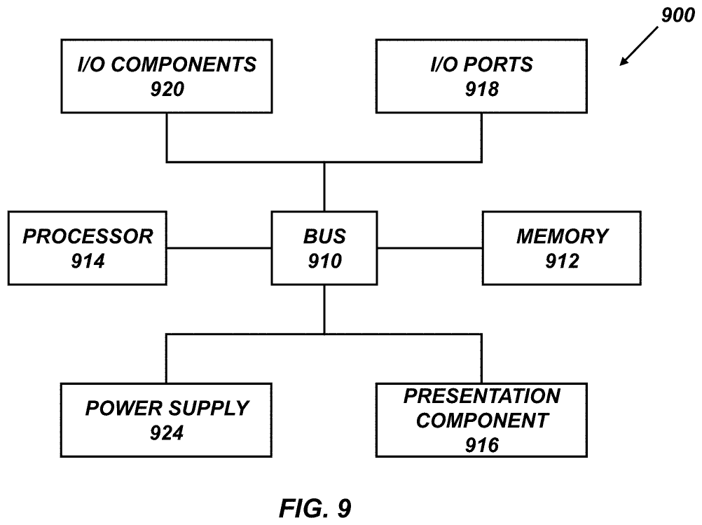

In operation, the three-dimensional fabrication apparatus 100 is configured to form a three-dimensional object, also referred to herein as a part, through an additive manufacturing process (e.g., adding layers of part material to form an object) and applying coloring layers (e.g., ink) at selected location on and/or between the layers during the additive manufacturing process. In particular, the three-dimensional fabrication apparatus 100 receives instructions from one or more software programs executed by a computing device (e.g., 900, FIG. 9). The instructions can be configured to indicate where to add layers of part material, and specific to the disclosed embodiments, where to add coloring at locations distanced from exterior surfaces of the part and/or on or immediately adjacent to one or more exterior surfaces of the part. The layering of part material and relative placement of coloring by the three-dimensional fabrication apparatus 100, as instructed by the software, results in the formation of the colorized three-dimensional object.

As discussed in greater detail below, depending on the structure of the three-dimensional object to be formed, the three-dimensional fabrication apparatus 100 can receive additional instructions to carry out the formation and coloring of the object. For example, objects that include shapes with an overhang can require a support structure to be formed by the apparatus 100, concurrently with the part material, to support the overhang and prevent undesired deformation of the part material during fabrication. To facilitate separation of a formed object from the support structure, a release layer can be interposed between the object and the support structure during the fabrication process. In contrast to manufacture of objects that do not include overhang features, coloring can be added to the release layer during manufacture of the object, rather than between part material layers. Alternatively, coloring can be added to the release layer and between part material layers. Applying colorization agent on top of a release layer can help achieve better contrast and darkness of the image than if the colorization agent was only applied on top of the first layer of deposited part material (e.g., on bottom facing sides of objects).

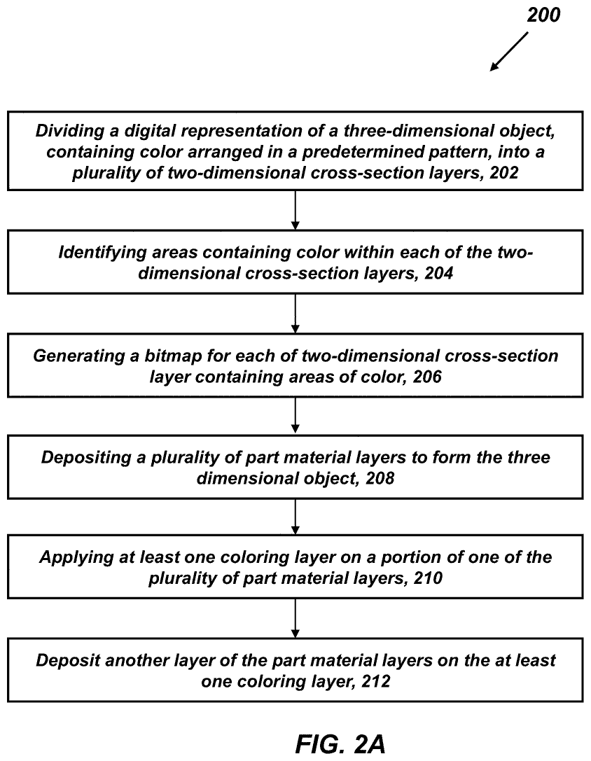

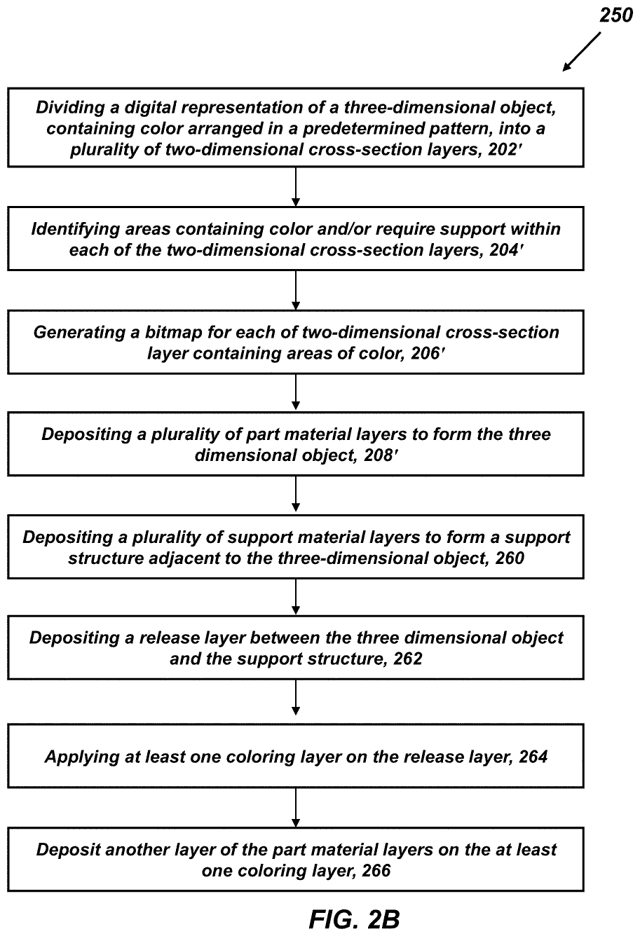

FIGS. 2A and 2B are flow diagrams presenting different embodiments of processes 200, 250 for form a three-dimensional object with coloring layers using the three-dimensional fabrication apparatus 100. It can be understood, that alternative embodiments of these processes can have greater or fewer operations and/or the operations can be performed in an order different than those illustrated in FIGS. 2A and 2B.

FIG. 2A depicts a process 200 for adding color during formation of a three-dimensional object 106 by the three-dimensional fabrication apparatus 100 which does not possess an overhanging portion, and includes operations 202-212.

In operation 202, the software virtually slices two dimensional cross-section layers from a digital representation of the three-dimensional object 106. The digital representation of the three-dimensional object 106 can be any three-dimensional file format suitable for use by the apparatus. Examples can include, but are not limited to, STL, COLLADA, OBJ, FBX, X3G, AMF, 3MF, VRML, FBX, and gcode. For the purpose of discussion herein, it is assumed that the two-dimensional cross-section layers extend in a horizontal plane (e.g., an x-y plane) and are stacked in a vertical direction (e.g., a z-direction). However, slices can be oriented in other directions, without limit.

Thereafter, the software identifies areas within the two dimensional cross-section layers that contain color (operation 204) and generates a bitmap for each two dimensional cross-section layer containing areas of color (operation 206). The results of operations 202-206 create a virtual design that can be interpreted by the three-dimensional fabrication apparatus 100 to form and color the object 106.

Relying on the virtual design created by the software, in operation 208, the three-dimensional fabrication apparatus 100 deposits at least one part material layer. Embodiments of the part material can have a variety of configurations. In one aspect, the part material can be one or more polymer materials. Examples of polymer materials can include acrylonitrile butadiene styrene (“ABS”), polyacrylates, polyolefins, cyclic olefin polymers and copolymers, polycarbonates, polyamides, polyimides, polyethylene and polybutylene terephthalate, liquid crystal polymer resins (“LCP”), polyether ether ketone (“PEEK”), thermoplastic elastomers (“TPE”), polystyrenes, polyvinyl chloride, polysulfones, polyacrylates, polyurethanes, polyamides, polyesters, polyolefins, epoxy resins, silicon resin, a diallyl phthalate resin, a cellulosic plastic, a resin-modified maleic acid resin, copolymers thereof, any other macromolecular structure, and combinations thereof. In certain embodiments the polymer is acrylonitrile butadiene styrene.

In operation 210, the three-dimensional fabrication apparatus 100 deposits at least one coloring layer on at least a portion of one of the plurality of part material layers to add color to the object at that portion. In certain embodiments, the at least one coloring layer can be an ink that includes one or more of dyes, pigments, and/or catalysts. As discussed in greater detail below, in some embodiments, the at least one coloring layer can be visible to the human eye, while in other embodiments, the at least one coloring layer can be invisible to the human eye unless illuminated by light within a predetermined wavelengths.

In operation 212, the three-dimensional fabrication apparatus deposits another layer of the part material layers on the at least one coloring layer.

The sequence of operations 210-212 can be repeated as necessary to form the three-dimensional object 106 which matches the digital representation of the three-dimensional object, including shape and dimensions, as well as location of coloring. As discussed in greater detail below, color can be added at multiple portions of a layer, at multiple layers, etc. throughout the processes of forming the three-dimensional object 106.

FIG. 2B depicts a process 250 for adding color during formation of a three-dimensional object 106 by the three-dimensional fabrication apparatus 100. The process 250 of FIG. 2B utilizes the operations 202′-208′, similar to operations 202-208 discussed with respect to FIG. 2A, with some modification for the creation and removability of a support structure. Additionally, the process 250 of FIG. 2B includes different processing operations 252-266 for adding coloration to the object 106.

In operation 202′, the software virtually slices two dimensional cross-section layers from an object 106, as discussed above regarding operation 202. Thereafter, in operation 204′, the software identifies areas within the two dimensional cross-section layers (e.g., overhang regions) that require support and generates an appropriate support structure. The software can further identify areas within the two-dimensional cross-section that contain color and areas of each layer where the support structure is adjacent to the object 106. Then, in operation 206′, the software generates a bitmap for each two dimensional cross-section layer containing areas of color.

In alternative embodiments, the operations 202′-206′ can be performed in a different order. As an example, the software can identify overhang regions of the three-dimensional object that require support and virtually generates a support structure for these overhang regions. The software can then virtually slice the digital representation that includes the support structure and the object into layers. The software can subsequently identify areas within the two-dimensional cross-section that contain color and areas of each layer where the support structure is adjacent to the object.

The results of operations 202′-206′ create a virtual design that can be interpreted by the three-dimensional fabrication apparatus 100 to form and color the object 106 and to form a support structure adjacent to the object 106 having the release layer interposed therebetween. Relying on the virtual design created by the software, the three-dimensional fabrication apparatus 100 deposits at least one part material layer to form the object 106 in operation 208′. Subsequently, the apparatus 100 deposits at least one support material layer to form the support structure adjacent to the object 106 in operation 220, and deposits at least one release layer between the three dimensional object—and the support structure in operation 262.

In one example embodiment, operations 208′ and 260 can happen simultaneously. That is, the part and the support structure can be deposited on the same layer, if both present on that layer. The process 250 (e.g., operations 220-222) can create the releasable support structure adjacent to the object 106. For a more detailed explanation of the process 250 for forming a support structure for the three-dimensional fabrication apparatus 100 is discussed in greater detail in PCT Application No. PCT/US2017/042223, incorporated herein by reference.

Embodiments of the part material employed by the process 250 can be the same as those discussed above with regards to the process 200. In certain embodiments, the part material can be a polymeric material. In some embodiments, the support material can be formed from the same material as the part material. In additional embodiments, the support structure can be formed from a polymeric material that is water soluble, solvent soluble, or alkali soluble. Examples can include water soluble wax, polyethylene oxide and glycol-based polymers, polyvinyl pyrrolidone-based polymers, methyl vinyl ether, or maleic acid-based polymers.

For the colorization, the three-dimensional fabrication apparatus 100 deposits at least one coloring layer on top of the release layer in operation 264. At least one part material layer is deposited over the coloring layer on the top of the release layer (e.g., a layer comprising a release agent, release ink, etc.) in operation 266. The operations 264-266 cause the coloring to absorb into the at least one part material layer at that location.

The operations 208′-266 can be repeated, as necessary, to form the three-dimensional object 106 which matches the virtual design including shape and dimensions, as well as location of colorization.

In accordance with an example embodiment of the present disclosure, the application of the coloring layer in processes 200 and 250 (e.g., operation 210 of FIG. 2A and 264 of FIG. 2B) is carried out by the three-dimensional fabrication apparatus 100 applying drops of coloring (e.g., ink) on deposited layers of part material and/or release layer (e.g., release agent layer). The drops of coloring in a coloring layer can include any combination of drops from one to an entire layer of coloring on a surface of the target layer (e.g., part layer or release layer).

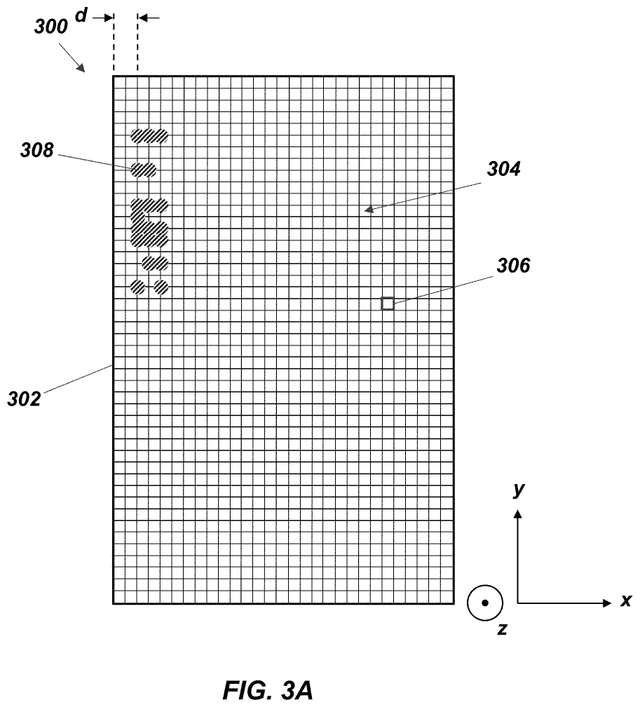

FIGS. 3A and 3B depict schematic representations of color deposition on one two-dimensional layer of deposited part material 300 in order to provide images to vertical surfaces of the three-dimensional object 106. In particular, FIG. 3A depicts a two-dimensional layer of deposited part material 300 (e.g., polymer layers) in a horizontal plane (e.g., x-y plane) created by a three-dimensional fabricating system (e.g., three-dimensional fabrication apparatus 100 discussed with respect to FIG. 1).

The layer of deposited part material 300 in FIG. 3A includes an exterior surface (also referred to as an edge or perimeter) 302 of the deposited part material layer 300, an interior (or infill) of deposited part material layer 304, representation of pixels 306, and drops of coloring 308 (e.g., color ink). As would be appreciated by one skilled in the art, the representation of pixels 306 are representations of the resolution and color gamut of the apparatus 100, which is commonly measured in dots per inch (DPI). The representation of pixels 306 can vary depending on the apparatus 100 and is not intended to be limited to the representation of pixels 306 in FIG. 3A. For example, the representation of pixels 306 can represent fabrication apparatus resolutions from 150 DPI to 16,000 DPI.

Continuing with FIG. 3A, the schematic representation of deposited part material 300 includes the dimension d representing a distance from the external surface 300 of the part material layer 300 to the closest drop of coloring 308. In other words, d is the depth or distance, measured from the outside surface of the printed object 106 at which the first drop of coloring 308 is deposited. During fabrication of the object 106 according to either of the processes 200, 250, the drops of coloring 308 are deposited at the distance d relative to the exterior surface 302 of the deposited part material in the x-y plane. Based on the implementation, the value ford of 0<d and can be adjusted from drop to drop of colorant 308. As discussed above, the portion of the interior 304 of the deposited part material layer 300 receiving the drops of coloring 308 can be subsequently covered by another deposited part material layer 304.

FIG. 3A is a particular, but non-limiting, example of possible drops placement on pixels provided to illustrate the coloring deposition pattern for vertical surfaces. As would be appreciated by one skilled in the art, the elements of FIG. 3A are for illustrative purposes only and are not made to scale. For example the proportions of drops are exaggerated to help with visualization. Various combinations and permutations can be used. Additionally, each drop of coloring 308 represented in FIG. 3A can be made of one or multiple drops of coloring, and each drop can be one single color drop or a combination of drops.

In certain example embodiments, the drops of coloring 308 are applied over the deposited part material layer 300 to apply color to horizontal surfaces of the object 106. Similarly, the drops of coloring 308 can be applied at or near an exterior surface (e.g., 302) of the deposited part material layer 300 to form images on vertical surfaces of the object 106. In certain embodiments, the drops of coloring 308 are applied at a small distance from the exterior surface 302 of the three-dimensional object 106.

As discussed with respect to FIGS. 2A and 2B, to form images on vertical walls, the vertical image of the three-dimensional object 106 is first sliced into two dimensional cross-sectional layers. In certain embodiments, the two-dimensional cross-section layers of the image can extend over one or more pixels 306, preferably 1-10, and more preferably 1-4. The one or more pixels 306 can be adjacent or not adjacent.

In certain example embodiments, the deposited part material layer 300 is at least partially soluble into the drops of coloring 308 (e.g., colorization agents). Similarly, the drops of coloring 308 can be at least partially soluble into the deposited part material layer 300. For example, the drops of coloring 308 can diffuse into the deposited part material layer 300 to obtain homogeneous color coverage and deposition on vertical surfaces, high resolution and improved color gamut, and to avoid excess bleed at the surface of the deposited part material layer 300. In certain embodiments, the surface properties of the drops of coloring 308 and the surface properties of the deposited part material layer 300 are adjusted to minimize ink bleed and maintain high image resolution with quality color gamut. Additionally, the rate of diffusion of the colorization agents into the deposited part material layer 300 can be adjusted to maintain good color accuracy, color gamut, and resolution, as would be readily determined by one of skill in the art.

In certain example embodiments, the temperature of a print chamber of the three-dimensional fabrication apparatus 100 (e.g., print head and ink delivery system 112) can be adjusted to improve penetration of the drops of coloring 308 into the deposited part material layer 300. In certain embodiments, the drops of coloring 308 undergo a phase change when jetted onto the deposited part material layer 300. For example, the drops of coloring 308 solidify after being deposited onto the deposited part material layer 300.

In certain example embodiments, the drops of coloring 308 are formulated with an additive promoting the adhesion of the drops of coloring 308 onto the deposited part material layer 300. For example, the color ink can be formulated with a drying agent to accelerate the fixation of the color ink onto the deposited part material layer 300. Alternatively or additionally, a drying or solidifying agent for color ink contained within the drops of coloring 308 can be blended with the deposited part material layer 300. In another example, at least a portion of the drops of coloring 308 reacts with at least a portion of the substrate material to form a strong bond between the drops of coloring 308 and the deposited part material layer 300.

Additionally, the drops of coloring 308 can undergo other phase changes during use. In one example, at least a portion of the drops of coloring 308 can evaporate (a liquid to gas phase transition) after deposition onto the deposited part material layer 300. In another example, and/or penetration into the surface of the deposited part material layer 300. In certain embodiments, at least a portion of the drops of coloring 308 dries or solidifies onto the deposited part material layer 300 (a liquid to solid phase transition). For example, the drops of coloring 308 can dry or solidify onto the deposited part material layer 300 by physical or chemical processes. In certain example embodiments, the drops of coloring 308 are allowed to at least partially dry, cure, solidify, and/or attach on the deposited part material layer 300 before the next layer of part material is deposited.

In certain example embodiments, the fixation of the drops of coloring 308 on the deposited part material layer 300 can be enabled or accelerated. For example, the fixation of the drops of coloring 308 on the deposited part material layer 300 can be enabled or accelerated by heat, light, and/or oxygen, as would be understood and implementable by those of skill in the art as desired.

In accordance with embodiments of the present disclosure, the drops of coloring 308 can be deposited at different stages of the object 106 formation processes. For example, the drops of coloring 308 can be deposited prior to depositing the deposited part material layer 300 of the object 106, deposited between the release layer and the first deposited part material layer 300 of the object 106, and/or deposited between the release layer and the first deposited part material layer of the object 106, which transfers to the first part material layer 300 of the object 106 deposited on top of the color ink layer.

In certain example embodiments, the drops of coloring 308 and release layer (e.g., release ink) composition can be adjusted to prevent excessive mixing and migration of one formulation into the other, and to maintain integrity of the printed image. In certain example embodiments, the drops of coloring 308 are immiscible with the chemistry of the release layer.

In certain example embodiments, the concentration of drops of coloring 308 can be varied based on location and application. For example, the drops of coloring 308 applied to a bottom facing perimeter and/or surfaces is higher than the concentration of drops of coloring 308 applied on top facing perimeter and/or surfaces. In another example, the concentration of drops of coloring 308 applied to a bottom facing perimeter and/or surfaces is lower than the concentration of drops of coloring applied on top facing perimeter and/or surfaces.

In certain example embodiments, the drops of coloring 308 for the same image or portion of image is applied at the same location on two or more different deposited part material layers 300 to achieve better contrast and darkness of the printed image on horizontal surfaces. The drops of coloring 308 can be applied to each of the deposited part material layer 300 with the same concentration of drops of coloring 308 on each deposited part material layer 300 or with different concentrations of drops of coloring 308 on each deposited part material layer 300. Additionally, the two or more layers of different deposited part material layers 300 with the drops of coloring 308 at the same location can vary. For example, two or more layers of different deposited part material layers 300 can be consecutive layers or not consecutive layers.

In some example embodiments, illustrated in FIG. 3B, additional drops of coloring 310 can be applied in combination with the drops of coloring 308 to create a background. For example, the additional drops of coloring 310 can be applied at a predetermined distance (e.g., distance c) from the drops of coloring 308 that form the image. In this manner, a monochromatic background behind the color image (e.g., provided by the drops of coloring 308) can be formed that provides opacity in areas where translucency is not desirable. In certain embodiments, a distance e between the exterior edge 302 of the deposited part material 300 and the drops of coloring 310 forming the monochromatic background is greater than the distance d from the exterior edge 302 of the deposited part material layer 300 to the drops of coloring 308 forming the image. As would be appreciated by one skilled in the art, the background color can be any color or combination of colors that allow an image to be viewable thereon. For example, the background can be black, the background can be white, or the background can be a color other than black or white.

As shown in FIG. 3B when the additional drops of coloring 310 are deposited further from the exterior edge 302 of the deposited part material layer 300, a monochromatic background is created to increase opacity behind the image provided by the drops of coloring 308 (if the deposited part material layer 300 is translucent). As would be appreciated by one skilled in the art, the background can be created behind only certain drops of coloring agent forming the image or it can be uniformly created behind the entire color image within the object 106. Additionally, the background can be formed by depositing drops of coloring agent at different depth or through phase separation of the deposited part material 300.

In certain embodiments, the deposited part material can undergo phase separation. For example, the deposited part material can undergo a phase separation to transform from clear or transparent to opaque. Additionally, the deposited part material can undergo phase separation over different areas. For example, the deposited part material can undergo phase separation in selective areas only or on an entire deposited part material layer 300. Phase separation can happen, for example, through reactive chemistry between the deposited part material and drops of coloring 308 and/or 310 (or other form of secondary material) deposited on the part material. In another example, phase separation can be a polymerization induced phase separation, where one component of the deposited material polymerizes causes phase segregation as a result of increased molecular weight. In a further embodiment, phase separation can occur through temperature change (e.g., cooling).

As would be appreciated by one skilled in the art, the portion of a deposited part material layer 300 onto which the drops of coloring 308 and/or 310 are applied can include any materials known in the art. As discussed above, the part material can be a polymer. In alternative embodiments, the part material can be one or more materials other than a polymer, such as a ceramics, composites, metals, glasses, or edible materials, such as food.

In certain example embodiments, the drops of coloring 308 and/or 310 are applied to the deposited part material layers 300 by the extruder assembly 102 (e.g., an extruder nozzle) or the ink delivery system 112 (e.g., an inkjet print head). As would be appreciated by one skilled in the art, the drops of coloring 308 and/or 310 can be applied to layers of part material deposited by any layer manufacturing technology that enables the creation of three-dimensional objects and allows the selective deposition of color at a voxel level.

In certain example embodiments, the drops of coloring 308 can be applied in different patterns to provide different visual effects. For example, the drops of coloring 308 can be deposited in a manner and at locations to provide an image on the object 106, to add colorization to the object 106, or can be applied inside an object 106 to form holographic images.

To provide the different visual effects, the extrusion pattern of deposited part material can be adjusted in application. For example, the extrusion pattern of deposited part material can be adjusted to modify a translucency level and light scattering of the object 106. Examples of such a modification include depositing the part material in a dense pattern to avoid air pockets within the part to minimize light scattering and maintain part translucency, or depositing the part material in a pattern that leaves air pockets within the part material to increase light scattering and reduce translucency of the part. In a further example, creating a grid pattern for the sparse infill underneath the solid exterior layers of the object 106 will create a white appearance when printing with translucent or transparent materials, due to the differences in refractive indexes and light scattering in clear parts. Likewise, a relatively thinner infill grid pattern will create a whiter appearance by producing more scattering in clear parts vs. a coarser infill pattern. Depending on the preferred visual effect, different infill patterns can be utilized. For example, a thinner infill pattern will produce whiter appearance when printing with clear materials with the thinnest infill grid patterns greatly enhancing the white appearance of clear parts.

Additionally, depending on the desired visual effect(s), the extrusion pattern modification can be the same throughout the object 106, or only exist in selected areas of the object 106. For example, a thinner infill pattern used throughout an entire infill of the object 106 will create a uniform white and/or opaque appearance of the object 106. The thinner infill can also be used in selected areas only where a whiter appearance is desired, while other areas of the object 106 are printed with sparser infill to create a more translucent appearance. The disclosed embodiments provides flexibility by varying patterns throughout an object 106, such that objects 106 can have both translucent and white and/or opaque areas in a same object 106 produced by selectively adjusting the density of the infill when depositing materials with some degree of translucency.

In certain embodiments, the drops of coloring 308 can be applied at different depths within an external surface of the object 106 to yield different visual and utilitarian effects. For example, the drops of coloring 308 can be applied at or close to the exterior surface 302 of the deposited part material 300 (e.g., relatively small distance d) or deep inside the object 106 at a distance from the external surface 302 of the deposited part material 300 such that it is not visible on the outside of the object 106 once the object 106 is completed (e.g., relatively large distance d).

As would be appreciated by one skilled in the art, the distance d from the external edge 302 of the deposited part material 300 in which the drops of coloring 308 are applied can be adjusted based on the level of translucency of the part material. For example, less translucent part materials may require the drops of coloring 308 to be applied closer to the most external edge of the deposited part material 300 (smaller distance d) while more translucent part materials will allow the drops of coloring 308 to be applied deeper within the object 106 (larger distance d) while still providing a desired effect (e.g., visual effect).

In certain embodiments, drops of coloring 308 are applied within the depth of the object 106 at a distance d that is configured such that the colorization provided by the drops of coloring 308 can be utilized as a wear and tear indicator for the object. For example, the distance d can be selected such that the color provided by the drops of coloring 308 is not visible on a freshly printed object 106, but would become visible as the outer portions of the part material layers are worn. That is, wear causes a reduction in distance d after the drops of coloring 308 are applied, which allows the color provided by the drops of coloring to be seen.

Alternatively, the drops of coloring 308 can be applied on exterior surface 302 of one or more deposited part material layers 300 and up to a pre-determined depth within the object 106 such that, the colored surface disappears when the object 106 is worn a distance extending to the pre-determined depth, and the surface of the object 106 will become the color of the deposited part material layer 300, indicating wear.

Applying the drops of coloring 308 at different depths can have other utilitarian effects. For example, the drops of coloring 308 applied within the depth of the object 106 can be used as a watermark or security feature, to hide text and/or images within a part, where the hidden features would be invisible on the part from the outside under normal viewing conditions by the human eye (e.g., when illuminated by ambient light, such as sunlight and artificial room illumination, such as incandescent, halogen, fluorescent, and/or LED), and would only be visible by way of special techniques, such as, but not limited to, a special reflective light, x-rays, using quantum dots, or other predetermined wavelengths of electromagnetic radiation (e.g., ultraviolet light, infrared light, etc.).

In certain example embodiments, the exterior surface 302 of the deposited part material layer 300 can be textured (e.g., pitted) to create a surface with high scattering properties, modifying its translucency/opacity of and altering the visual perception of the object 106. In various embodiments, the surface of the object 106 can be pitted through chemical or physical techniques. Examples of chemical techniques can include application of a strong plasticizer, or other materials with the ability to attack the deposited part material, on the deposited part material layer 300 to create holes or micro-cracks in the deposited part material layer 300 to increase light scattering. Examples of physical techniques can include physical indentation, such as by applying a roller with pins to the exterior surface of the object 106 to create small dents at the exterior surface.

In certain example embodiments, the transparency of translucent fabricated objects 106 can be increased by applying a chemical agent (e.g., a plasticizer). The chemical agent can be applied onto deposited part material layers 300 to make the part material flow and fill in the voids within the part to reduce light scattering and improve transparency. As would be appreciated by one skilled in the art, the chemical agent can be deposited at different stages of manufacturing. For example, the chemical agent can be deposited during the layer manufacturing process. Alternatively, the chemical agent can be applied onto one or more exterior surfaces of the object 106 after the three-dimensional object 106 is formed. Similarly, the chemical agent can be applied to different areas of the object 106 for different effects. For example, the chemical agent can be applied in certain areas of the object 106 to increase transparency in those specific areas of the object 106. Alternatively, the chemical agent can be applied on the entire three-dimensional object 106.

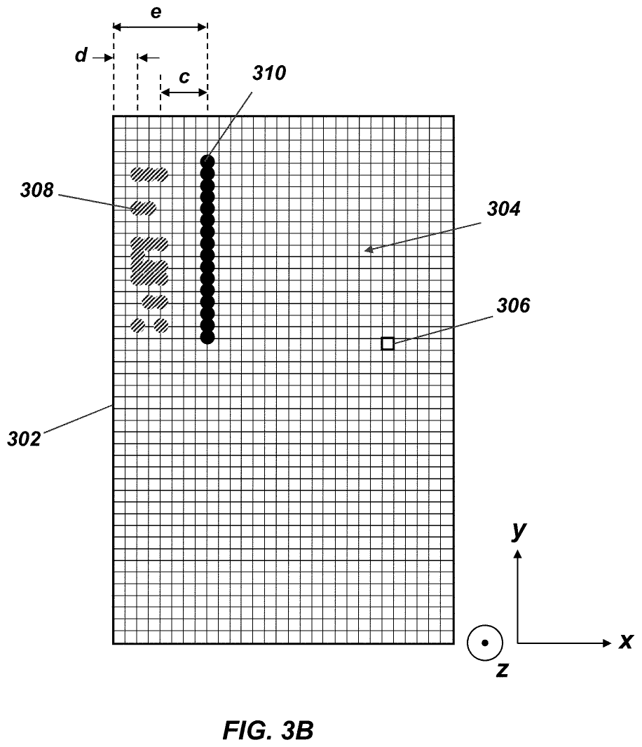

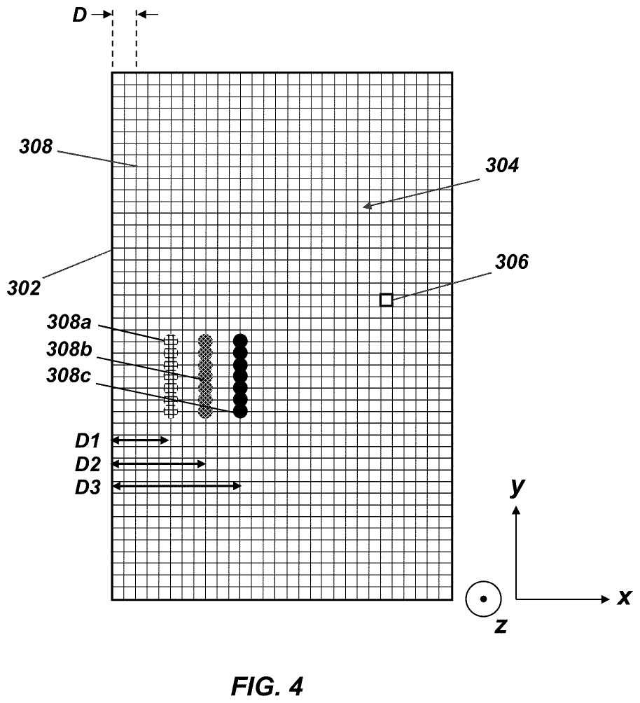

FIG. 4 depicts a schematic representation of color deposition on one layer of deposited part material 300 to apply color inside the object 106 to create utilitarian features such as wear/tear indicator, or watermark or other security feature. In particular, FIG. 4 depicts the layer of deposited part material 300 in which three differentiated drops of coloring 308a, 308b, 308c are deposited at different depths from what will be the external edge 302 (e.g., the external surface) of the object 106 to act as a wear indicator. As depicted in the layer of deposited part material 300 of FIG. 4, the drops of coloring 308 are deposited at a minimum distance D from the external edge 302 of the deposited part material layer 300 in the x, y plane such that the thickness D of part material between the external edge 302 of the object 106 and the area where the drops of coloring 308a, 308b, 308c are applied provides sufficient opacity for the formed image to be invisible from the outside once the part is completed.

As would be appreciated by one skilled in the art, depending on the application, a unique pattern or multiple patterns, for the drops of coloring 308a, 308b, 308c can be formed at distances greater than distance D (e.g., D1, D2, D3, respectively). Additionally, the same pattern can be used at different depths D1, D2, D3, etc. with different colors of the drops of coloring 308a, 308b, 308c being used for each depth to identify different areas (e.g., color at different depths representing different degrees of wear). For example, a first color deposition provided by drops of coloring 308a (e.g., blue) can be performed at depth D1, a second color deposition provided by drops of coloring 208b (e.g., yellow) can be performed at depth D2, and a third color deposition provided by drops of coloring 308c (e.g., red) can be performed at depth D3. Continuing the example, the visible appearance of the first color (e.g., blue) can indicate minimal or no wear, the second color (e.g., yellow) can provide a warning of mild wear, and the third color (e.g., red) can indicate excessive wear of the object 106. Alternatively, different patterns with one or multiple colors can be formed at the different depths D1, D2, D3.

In general, the image created by application of the drops of coloring 308 extends in depth by a constant number of pixels within the object 106. In accordance with an example embodiment of the present disclosure, the number of pixels jetted in depth is automatically adjusted by the software based on the brightness of the image color (e.g., the brightness of one or more pixels located at a distance closest to the external surface 302. Similarly, the number of pixels jetted in depth can be varied to produce lighter or darker colors. In certain embodiments, the jetted pixels are overlaid by ½ or a fraction of a pixel. In certain embodiments, the first pixel is at a small distance from the exterior edge 302 of the deposited part material layer 300. For example, the first pixel can be a distance of 1-20 pixels, preferably 1-10 pixels, or preferably 1-5 pixels. In some embodiment, the two-dimensional cross-section of the image having a width of one or several pixels, is further dithered to match the colors of the image.

In certain embodiments, the part material (e.g., extruder polymer) has some transparency or translucency to achieve a desired color brightness on vertical surfaces and/or to achieve uniform color on all surfaces of the object 106. In certain embodiments, the translucency level of the material is adjusted to achieve minimal loss of Chroma between vertical and horizontal surfaces. In certain embodiments, objects 106 fabricated from a translucent part material have bright and uniform color on all exterior surfaces 302. In certain embodiments, when the three-dimensional object 106 has sloped surfaces, the drops of coloring 308 of consecutive deposited part material layers 300 forming the slope can be overlapped on different layers by a small amount to achieve continuity of the color image.

In certain embodiments, the deposited part material has some translucency to allow for at least a portion of the image printed on one layer to be visible through the next adjacent layer. In certain embodiments, the optical transmittance of the deposited part material is adjusted to allow for at least some portion of the image covered by an adjacent layer of deposited part material to be visible through the corner edge of that adjacent layer of deposited part material. In certain embodiments, the at least portion of the image covered by an adjacent layer of deposited part material visible through the corner edge of that adjacent layer of deposited part material allows for continuity of the color image and complete color coverage of the deposited part material.

In another embodiment, the drops of coloring 308 are applied inwards at a predetermined distance h from the exterior facing surface of top and/or bottom layers of the object 106 (e.g., last and first deposited part material layers 300). The predetermined distance h can be one or multiple layer thickness of deposited part material. In this manner, uniform color on the formed object 106 can be obtained. For example, for top facing surfaces, if a top facing section of the object is at layer “n” of deposited part material, the drop of coloring 308 can be applied on top of layer “(n−1)”, so that there will be a thickness h equals to 1 layer of deposited part material between the image and the outside facing surface of the object. Alternatively, for bottom facing surfaces, if “a” is the first layer of deposited part material 300, then the coloring agent can be applied on top of layer “a.” In this case also, there will be a thickness h equals to 1 layer of deposited part material between the image and the outside facing surface of the object. Similarly, if h was equal to 2 layer thicknesses of deposited part material, and the coloring agent was applied at that distance x from the outside facing surface of top and bottom layers, then the coloring agent would be applied on top of layer “n−2” for top facing surfaces, and on top of layer “a+1” for bottom facing layers.

In another embodiment, the same bitmap/image can be replicated on two or more layers away/inwards from the exterior facing surface of the printed object (the exterior edge 302), to enhance appearance of the colored object. For example, a darker color than if the image was printed on one layer only. In one embodiment, the 2 or more layers can be adjacent. In another embodiment, the 2 or more layers are not adjacent, with at least one other layer interposed therebetween.

In a further embodiment, the saturation of the drops of coloring 308 can be adjusted based on the angle of the surface of the object 106, to maintain a uniform color on the object 106. As an example, if the ink saturation on the vertical wall is 1, the saturation depending can be reduced on the normal to the object surface. The lowest saturation is on the flat surface, 0.5. It can be understood that the appropriate saturation for a given object 106 will vary for different printing materials and inks.

### EXAMPLES

The following non-limiting examples illustrate the utilization of drops of coloring 308 (e.g., deposition of colorization) in accordance with the disclosed embodiments. These examples are only for illustrative purposes to depict the various alternatives for implementing the disclosed embodiments. All of the tests within the examples were performed using Rize, Inc. three-dimensional printing machine prototypes constructed internally. The prototypes were equipped with a proprietary extruder head and one or more Ricoh Gen4 piezoelectric print heads. In addition, proprietary software and firmware were used for slicing of the computer-aided design (CAD) models and driving the printers. As would be appreciated by one skilled in the art, any combination of three-dimensional printing apparatus' and software can be utilized without departing from the scope of the disclosed embodiments.

### Example 1: Printing on Materials of Different Translucency

In Example 1, three experiments were performed under varied conditions. In the first experiment, a part material (e.g., for forming the deposited part material layer 300) was formed from a clear cyclo-olefin polymer that was compounded with boron nitride at different levels. The compounded material was processed into a filament form to be used on the Rize Inc. three-dimensional printing machine (e.g., similar to three-dimensional fabrication apparatus 100). The boron nitride filler addition resulted in filaments having different levels of translucency. During the test four different filaments with loadings of 2, 5, 10 and 20 wt. % were evaluated. The same parts were printed with each filament for comparison.

In the experiment, the three-dimensional object of a cuboid was printed with a shaded circle color deposition applied on the top facing face with each of the four filaments and the same blue ink (e.g., drops of coloring 308). After formation of the cuboids, C* Chroma and L* lightness values of the color of the blue shaded circle were measured using a Color Muse colorimeter device. Lightness L* is the brightness of an area judged relative to the brightness of a similarly illuminated area that appears to be white or highly transmitting. It is a number on a scale of 0-100. A value of 0 indicates total absorption, or black. A value of 100 indicates total light reflectance, or white. Chroma C* is the degree of colorfulness of an area judged as a proportion of the brightness of a similarly illuminated area that appears white or highly transmitting. It is the visual difference from a grey, on a scale 0-100. A C* value of 0 represents a grey, while the higher the C* value and the brighter the color is.

A second series of cuboids were printed with each of the four filaments with the blue shaded circle printed on the second to last layer of the cuboid and the color deposition layer was covered by one layer of deposited polymer part material, to simulate printing of the image within some depth of the material. Again, the Chroma C* and lightness L* of the blue shaded circle were measured on the second series of cuboids. Thereafter, the differences in Chroma and lightness of the blue shaded circle when printing at the surface vs. at some depth of the material (in this case depth equal to one layer of deposited polymer) were compared.

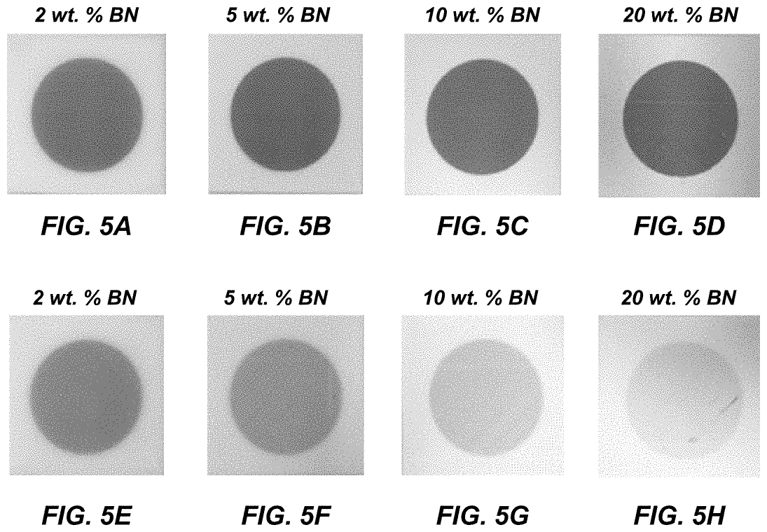

FIGS. 5A-5H depict the two sets of printed cuboids with the blue shaded circles colorized thereon/therein. The top row (FIGS. 5A-5D) show the first reference series with the blue shaded circle printed on the top layer of deposited polymer and boron nitride levels at 2, 5, 10 and 20 wt. % from left to right. The bottom row (FIGS. 5E-5H) show the corresponding second series cuboids with the blue shaded circle printed on the second to last layer of deposited polymer (printed image covered by one layer of deposited polymer) and boron nitride levels at 2, 5, 10 and 20 wt. % from left to right. FIGS. 5E-5H depict how the cuboids showed an increasing loss of colorfulness of the colorized blue shaded circle as the filament became less translucent with increased boron nitride levels.

The results of the color measurement for the first example of experiments are provided in TABLE 1 below.

TABLE 1

| | C* (average of 5 data points) | | | L* (average of 5 data points) | | |
|---|---|---|---|---|---|---|
| Boron | Image printed on | Image printed on | | Image printed on | Image printed on | |
| Nitride | last layer of | second to last layer of | | last layer of | second to last layer of | |
| loading | deposited polymer | deposited polymer | AC* | deposited polymer | deposited | AL* |
| 2 wt. % | 38.1 | 27.0 | −11.1 | 62.7 | 70.9 | 8.2 |
| 5 wt. % | 37.9 | 13.8 | −24.1 | 61.9 | 79.0 | 17.1 |
| 10 wt. % | 40.4 | 10.7 | −29.7 | 61.0 | 82.2 | 21.2 |
| 20 wt. % | 41.5 | 2.9 | −38.6 | 61.3 | 88.6 | 27.3 |

FIGS. 5A-5H and TABLE 1 show the differences in Chroma AC* between the blue shaded circle printed below and the blue shaded circle printed on top of the deposited polymer layer. The AC* values in this comparison were all negative, so the color of the blue shaded circle under a polymer layer was not as vibrant when not printing directly at the surface of the deposited polymer. Additionally, the AC* were increasingly higher as the loading of boron nitride increased and the filament was less translucent, so the Chroma of a blue shaded circle not printed directly at the surface of the cuboid was impacted by the translucency level of the deposited polymer.

Also of note, when printing at the surface of the deposited polymer, the translucency level of the filament had no or minimal impact as measured C* values were within the same range. The translucency of the filaments did not affect the darkness of the printed image when it was printed at the surface of the deposited polymer, but there was a difference in darkness when printed within some depth of deposited polymer (in this case at a depth equal to the thickness of one layer of deposited material): lightness L* values of the blue shaded circle were similar for all four filaments when the image was printed on the last deposited layer, but lightness L* values increased as the loading of boron nitride increased. The differences AL* in lightness of the blue shaded circle deposited below the surface of the deposited polymer vs. the top surface increased with the loading level of boron nitride as the filaments were getting less translucent.

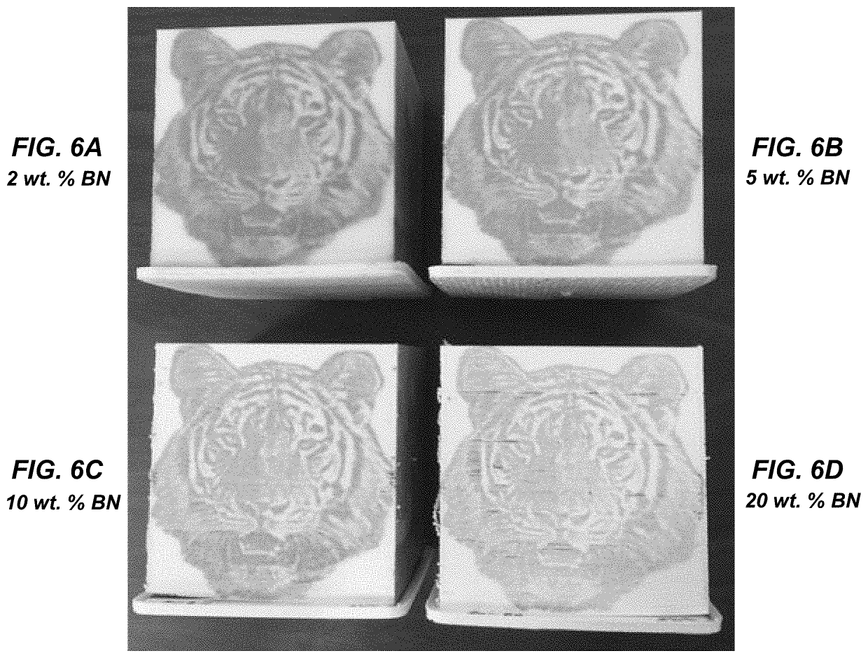

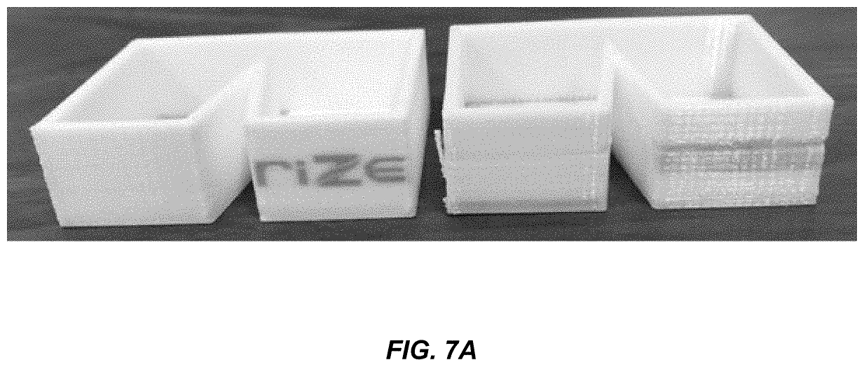

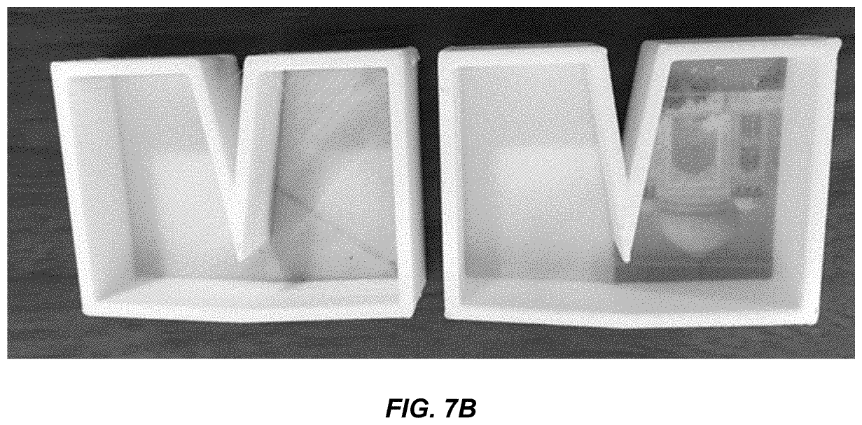

In a second experiment, following the parameters of the experiment performed with the shaded circles on cuboids, a three-dimensional cuboid with colorization deposited on four sides was printed. The cuboid was printed with various images (e.g., tigers) deposited on all four external walls was printed with each of the four filaments and the same blue ink used for the blue shaded circles. The images on the vertical walls were printed within the depth of the wall of the cuboid, at a small distance from the outer edge of the wall equal to four pixels. FIGS. 6A-6D depicts each of the four colorized sides of the cuboid. In FIG. 6, the first side in the first row (FIG. 6A) has 2 wt. % boron nitride, the second side in the first row (FIG. 6B) has 5 wt. % boron nitride, the first side in the second row (FIG. 6C) has 10 wt. % boron nitride, and the second side in the second row (FIG. 6D) has 20 wt. % boron nitride. The image distortion, intensity and darkness were visually assessed for each side. The side printed with the filament having the least amount of boron nitride, hence the more translucent filament (FIG. 6A), had the brightest images and was the most chromatic. The image darkness and colorfulness decreased as the loading of boron nitride increased and the filament became less translucent (image appearance changed from bright blue to a duller, greyish blue color).

In a third experiment in Example 1, a set of cyan, magenta, yellow and black color agents developed by Rize Inc. were used to print full color parts (not depicted). Two different filaments were tested. The first one was a blend of cyclo-olefin polymers and 1 wt. % TiO₂. The filament was opaque white. The second filament was the same blend of cyclo-olefin polymers as before, but with 2 wt. % boron nitride instead of the TiO₂. The filament had some translucency. A part formed as a box with the same image on all four external vertical faces and on the internal horizontal face was printed with each filament and the same set of color agents, and the uniformity of the image on the different faces was examined. On the horizontal face, image was printed at the surface of the deposited polymer layer. On the vertical faces, image was printed at a small distance from the perimeter edge of the wall equal to four pixels. The box printed with the more translucent boron nitride filled filament showed a rather uniform color on all sides and the images printed on the vertical walls appeared similar to the image printed on the horizontal face. The box printed with the more opaque TiO₂ filled material did not appear uniform in color as the images on the vertical faces were noticeably less bright than on the horizontal face.

### Example 2: Targeting Ink/Base Material Solubility to Achieve Fixation of Ink onto Material

In Example 2, a part in the form of a small hollow box having an image on the internal horizontal face and Rize's logo on one of the vertical face was printed on an alpha prototype printer with a blue ink based on mineral oil and a dye, and with two different filaments. One filament was a blend of cyclo-olefin polymers which is partly soluble in the ink; the other filament was a polycarbonate which is not soluble in the ink. The image and text on the box printed with the cyclo-olefin polymers blend filament had a good image quality, and resolution, the text was easily readable, and there was no bleed and no smear of the ink (the right objects in FIGS. 7A and 7B). The image and text on the box printed with the polycarbonate filament were completely blurred and indiscernible, the ink bled and could be easily rubbed off on the image printed on the horizontal surface (the left objects in FIGS. 7A and 7B).

### Example 3: Image Transfer to Apply Color on the Bottom Facing Surface of a Three-Dimensional Object

In Example 3, a part in the form of a hollow box having an image on the external facing bottom (not depicted) was printed on Rize's prototype printer.

In a first experiment, the first layer of deposited polymer was deposited first, and then the image was printed on that first layer of deposited polymer. In this case, the image was at a distance from the external bottom face of the three-dimensional object equal to one layer thickness. When observing the part, color did not diffuse to the external layer of deposited polymer, and color on the bottom face looked faint.

The experiment was repeated, but this time prior to depositing the first layer of deposited polymer, color ink was jetted to print the image on top of the release ink layer. The first layer of deposited polymer was then deposited on top of the jetted color ink so that the deposited polymer contacted the jetted color ink. In this case, the color ink contacted the external bottom face of the three-dimensional object. The same image was then printed again on top of the first layer of deposited polymer. When observing the part, the image printed on top of a release ink layer had transferred to the external face of the three-dimensional object deposited on top of the printed image layer, and the image on the part looked brighter and more colorful.

### Example 4: Replicating Image on Multiple Layers for Bottom Facing Surfaces to Achieve Darker Color

In Example 4, a part in the form of a box having an image on the external facing bottom (not depicted) was printed on Rize's prototype printer.

First the box was printed with the image printed on top of the first part layer of deposited polymer at 4 dpp. When looking at the bottom of the completed part, the image was not at the surface but at a distance equal to the first part layer thickness of deposited polymer. The image appeared faint.

A second box was printed, with the image printed on top of the first part layer of deposited polymer at 2 dpp. The image appeared lighter when compared to the image on the box printed at 4 dpp.

A third box was printed, at 2 dpp of color ink, but this time the image was printed on top of both the first part layer and second part layer of deposited polymer. The image appeared darker than the second box, and looked very similar in intensity to the image on the first box printed at 4 dpp. In addition, the image had better sharpness compared to the other two.

### Example 5: Applying Color on Vertical Surfaces

In Example 5, three experiments were conducted using similar methodologies. In the first experiment, a part in the form of a box having the same image on each of the four external vertical walls as well as the internal bottom (not depicted) was printed on Rize's prototype printer.

To print the image on the internal horizontal bottom, the ink was deposited at the surface of the deposited polymer. An image was printed in one single layer. On each of the four vertical walls, the ink was deposited within the depth of the polymer, at a small distance from the perimeter edge of the deposited polymer equal to four pixels. The image was printed in multiple layers, each layer comprising a two-dimensional cross-section of the vertical image. The integrity of the image was maintained between vertical and horizontal images, the images on the vertical faces all had good resolution. The process used to print images on vertical faces produced the same image quality as the process used to print images horizontally.

In the second experiment, a part in the form of a box with images on the vertical walls was printed on Rize's prototype printer. Rize's proprietary software was used to determine the number of jetted pixels and select which pixels were jetted or skipped from four adjacent pixels, one being the most outer pixel closer to the perimeter edge of the deposited layer, and four being the most inner pixel.

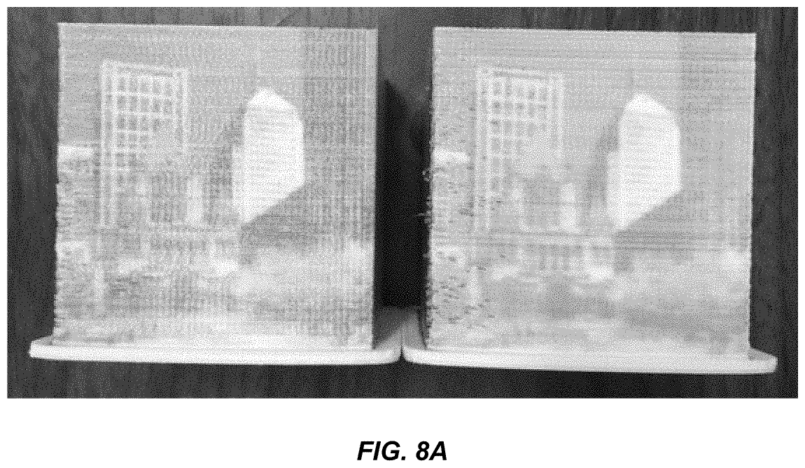

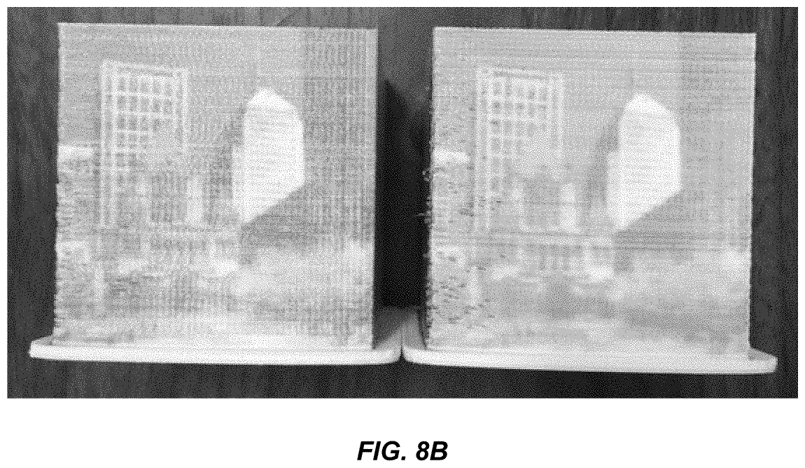

One box was printed jetting pixels one, two and three. Another box was printed with the same number of jetted pixels, but this time jetting pixels two, three and four. The resulting images on the box appeared lighter and not as sharp when depositing the first pixel further away from the perimeter edge of the deposited polymer. FIG. 8A depicts the resulting images, with the left image in FIG. 8A being the side of the box with jetting pixels one, two and three and the right image being the side of the box with jetting pixels two, three and four.

In the third experiment, a part in the form of a box with images on the vertical walls was printed on Rize's prototype printer. In this experiment only one pixel was jetted. Rize's proprietary software was used to determine the position of the jetted pixel, one being the most outer pixel closer to the perimeter edge of the deposited layer, and four being the most inner pixel. A first box was printed jetting pixel number two and a second box was printed jetting pixel number four. The images on the box appeared lighter and not as sharp when printing further away from the perimeter edge of the deposited polymer. The images on boxes printed with one pixel also looked much lighter than boxes printed above with three pixels. FIG. 8B depicts the resulting images with the left image in FIG. 8B being the side of the box with jetting pixel two and the right image being the side of the box with jetting pixel four.

FIG. 9 depicts an illustrative suitable computing device 900 that can be used to implement the computing methods/functionality described herein and be converted to a specific system for performing the operations and features described herein through modification of hardware, software, and firmware, in a manner significantly more than mere execution of software on a generic computing device, as would be appreciated by those of skill in the art. One illustrative example of such a computing device 900 is depicted in FIG. 9. The computing device 900 is merely an illustrative example of a suitable computing environment and in no way limits the scope of the disclosed embodiments. A “computing device,” as represented by FIG. 9, can include a “workstation,” a “server,” a “laptop,” a “desktop,” a “hand-held device,” a “mobile device,” a “tablet computer,” or other computing devices, as would be understood by those of skill in the art. Given that the computing device 900 is depicted for illustrative purposes, embodiments of the present disclosure may utilize any number of computing devices 900 in any number of different ways to implement a single embodiment of the present disclosure. Accordingly, embodiments of the present disclosure are not limited to a single computing device 900, as would be appreciated by one with skill in the art, nor are they limited to a single type of implementation or configuration of the example computing device 900.

The computing device 900 can include a bus 910 that can be coupled to one or more of the following illustrative components, directly or indirectly: a memory 912, one or more processors 914, one or more presentation components 916, input/output ports 918, input/output components 920, and a power supply 924. One of skill in the art will appreciate that the bus 910 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 9 is merely illustrative of an exemplary computing device that can be used to implement one or more embodiments of the present disclosure, and in no way limits the disclosed embodiments.

The computing device 900 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CD-ROM, digital versatile disks (DVD) or other optical or holographic media; magnetic cassettes, magnetic tape, magnetic disk storage or other magnetic storage devices that can be used to encode information and can be accessed by the computing device 900.

The memory 912 can include computer-storage media in the form of volatile and/or nonvolatile memory. The memory 912 may be removable, non-removable, or any combination thereof. Exemplary hardware devices are devices such as hard drives, solid-state memory, optical-disc drives, and the like. The computing device 900 can include one or more processors that read data from components such as the memory 912, the various I/O components 920, etc. Presentation components 916 present data indications to a user or other device. Exemplary presentation components include a display device, speaker, printing component, vibrating component, etc.

The I/O ports 918 can enable the computing device 900 to be logically coupled to other devices, such as I/O components 920. Some of the I/O components 920 can be built into the computing device 900. Examples of such I/O components 920 include a microphone, joystick, recording device, game pad, satellite dish, scanner, printer, wireless device, networking device, and the like.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the disclosed embodiments will be apparent to those skilled in the art in view of the foregoing description. Accordingly, this description is to be construed as illustrative only and is for the purpose of teaching those skilled in the art the best mode for carrying out the disclosed embodiments. Details of the structure may vary substantially without departing from the spirit of the disclosed embodiments, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the disclosed embodiments. It is intended that the disclosed embodiments be limited only to the extent required by the appended claims and the applicable rules of law.

It is also to be understood that the following claims are to cover all generic and specific features of the embodiments described herein, and all statements of the scope of the disclosed embodiments which, as a matter of language, might be said to fall therebetween.

One skilled in the art will appreciate further features and advantages of the disclosure based on the above-described embodiments. Accordingly, the present application is not to be limited by what has been particularly shown and described, except as indicated by the appended claims. All publications and references cited herein are expressly incorporated by reference in their entirety.

1. A method for applying coloring during a three-dimensional fabrication process, the method comprising:
virtually slicing, using a processor, a digital representation of a three-dimensional object with color into a plurality of two dimensional cross-section layers;
identifying, using the processor, areas containing color within each of the plurality of two dimensional cross-section layers of the three-dimensional object;
generating, using the processor, a bitmap for each of the plurality of two dimensional cross-section layers containing the areas containing color;
depositing, using the three-dimensional fabrication apparatus in an additive process, a first part material layer corresponding to a first layer of the plurality of two-dimensional cross-section layers;
depositing, using the three-dimensional fabrication apparatus in an additive process, at least one first coloring layer on at least a portion of the first part material layer; and
depositing, using the three-dimensional fabrication apparatus in an additive process, a second part material layer corresponding to a second layer of the plurality of two-dimensional cross-section layers on the at least one first coloring layer.

2. The method of claim 1, wherein the at least one first coloring layer is deposited at a predetermined distance from an exterior edge of the first part material layer.

3. The method of claim 2, wherein the predetermined distance is dimensioned such that a feature formed by the at least at least one first coloring layer is invisible from an external edge of the three-dimensional object under illumination by ambient light.

4. The method of claim 3, wherein the predetermined distance is such that a feature formed by the at least at least one first coloring layer is visible from an external edge of the three-dimensional object under illumination by ambient light.

5. The method of claim 2, wherein the predetermined distance exceeds a pixel width.

6. The method of claim 5, wherein the first coloring layer covers only one pixel width.

7. The method of claim 5, wherein the first coloring layer covers a width of multiple pixels.

8. The method of claim 7, wherein the multiple pixels are adjacent to one another.

9. The method of claim 7, wherein the multiple pixels are not adjacent to one another.

10. The method of claim 7, wherein the number of multiple pixels is adjusted based upon a brightness of a pixel of an image formed by the first coloring layer that is closest to an external edge of the three-dimensional object.

11. The method of claim 3, wherein the feature is a watermark or security feature is only visible under illumination by electromagnetic radiation of a predetermined wavelength range.

12. The method of claim 3, wherein the feature is a wear indicator that is only visible when external edges of the part material layers are worn off of the three-dimensional object to a depth exceeding the predetermined depth.

13. The method of claim 1, wherein at least one of the first and second part material layers is configured to undergo a phase separation over time to transition from a clear or transparent appearance to opaque appearance.

14. The method of claim 1, wherein the at least one first coloring layer is configured to undergo a phase change when deposited on the part material layers.

15. The method of claim 1, wherein at least one second coloring layer is deposited on the first part material layers at a different depth within the three-dimensional object different than of the first part material, thereby creating a monochromatic background to a color image created by the at least one first coloring layer.

16. The method of claim 1, further comprising depositing, using the three-dimensional fabrication apparatus in an additive process, a support structure material layers to form a support structure configured to provide mechanical support to at least one overhang portion formed in the three dimensional object by the first and second part material layers.

17. The method of claim 16, further comprising depositing, using the three-dimensional fabrication apparatus, a release layer between the support structure and either of the first and second part material layer.

18. The method of claim 17, wherein the release layer and the coloring layer are immiscible with respect to one another.

19. The method of claim 1, wherein the at least one first coloring layer comprises a color ink.

20. The method of claim 1, wherein the first and second of part material layers are formed from a polymer material.

21. The method of claim 1, wherein the at least one coloring layer is configured to achieve at least partially diffuse into at least one of the first part material layer and the second part material layer.

22. The method of claim 1, wherein the first and second part material layers are partially soluble in the at least one first coloring layer.

23. The method of claim 1, wherein the identified area of the object having color is converted into a two-dimensional image file.

24. The method of claim 1, wherein the first and second part material layers are translucent.

25. The method of claim 1, wherein a translucency of at least one of the first and second part materials layers is adjusted to achieve a predetermined Chroma minimum between vertical and horizontal surfaces of a three dimensional object formed therefrom.

26. The method of claim 25, wherein a difference in Chroma, of a same color or image formed by the first coloring layer, between horizontal and vertical surfaces of the three-dimensional object is less than 30 units and more less than 20 units.

27. A method, comprising:
forming, by a three-dimensional fabrication apparatus, a three-dimensional object through an additive manufacturing process, the three-dimensional object comprising a plurality of part material layers and at least one coloring layer applied upon at least one of the plurality of part material layers;
selecting, by the three-dimensional fabrication apparatus, at least one extruding pattern for at least one part layer of the plurality of part layers; and
extruding, by the three-dimensional fabrication apparatus, the at least one extruding pattern at the at least one part layer within the plurality of part layers to create a visual effect.

28. The method of claim 27, wherein at least one extruding pattern is configured to deposit the at least one part layer in a dense pattern configured to minimize light scattering and maintain translucency of the at least one coloring layer within the three-dimensional object.

29. The method of claim 27, wherein the at least one extruding pattern is configured to deposit the at least one part layer with air pockets configured to increase light scattering and reduce translucency of the at least one coloring layer within the three-dimensional object.

30. The method of claim 27, wherein the at least one extruding pattern is configured to deposit the at least one part layer in an infill grid underneath exterior edges of the plurality of part material layers that create a white appearance when the plurality of part material layers are translucent or transparent materials

31. The method of claim 27, further comprising texturing a surface of the three-dimensional object to increase opacity/reduce translucency.

32. The method of claim 32, wherein the texturing comprises chemically applying plasticizer or physically indenting the surface of the three-dimensional object.

33. A system, comprising:
a computing device including at least one processor configured to execute instructions operative to:
virtually slice a digital representation of a three-dimensional object with color into a plurality of two-dimensional cross-section layers;
identify areas containing color within each of the plurality of two-dimensional cross-section layers of the three-dimensional object; and
generate a bitmap for each of the plurality of two-dimensional cross-section layers containing the areas containing color; and
a three-dimensional fabrication apparatus comprising an extruder assembly and a print head, the three-dimensional fabrication apparatus configured to:
deposit, by the extruder assembly, a first part material layer corresponding to a first layer of the plurality of two-dimensional cross-section layers;
deposit, by the print head, at least one first coloring layer on at least a portion of the first part material layer; and
deposit, by the extruder assembly, a second part material layer corresponding to a second layer of the plurality of two-dimensional cross-section layers on the at least one first coloring layer.
